(19) United States
(12) Patent Application Publication
(10) Pub. No.: US 2025/0252325 A1
(43) Pub. Date: Aug. 7, 2025

(54) SEMANTIC MODERATION OF CONVERSATIONAL AGENTS

(71) Applicant: Dell Products L.P., Round Rock, TX (US)

(72) Inventors: Iam Palatnik de Sousa, Rio de Janeiro (BR); Karen Stéfany Martins, Belo Horizonte (BR); Isabella Costa Maia, São Paulo (BR); Leandro Takeshi Hattori, Campo Grande (BR); Shary Beshara, Cairo (EG)

(73) Assignee: Dell Products L.P., Round Rock, TX (US)

(21) Appl. No.: 18/430,914

(22) Filed: Feb. 2, 2024

(51) Int. Cl. G06N 5/025

(52) U.S. Cl. CPC G06N 5/025

(57) ABSTRACT

Techniques are disclosed for semantic moderation of conversational agents. An example system includes a memory having instructions, and a processor communicatively coupled to the memory and configured to execute the instructions. Example instructions include: scoring a received input string against a plurality of target classes to derive two or more scores, wherein each target class is associated with an independent score, and the scoring is performed without applying a softmax function to the independent scores; using the scores to generate a rule-based determination that indicates whether to pass or filter the input string; upon a determination to filter the input string, performing filtering processing on the input string; and otherwise, performing output processing on the input string.

### FIELD

Example embodiments generally relate to artificial intelligence applied to content moderation. More specifically, at least some embodiments relate to systems, hardware, software, computer-readable media, and methods for artificial intelligence applied to content moderation for conversational agents, also known as chatbots.

### BACKGROUND

Conversational agents have become integral in facilitating user interaction with a vast array of informative content, including documentation, search results, and customer service inquiries. These AI-driven interfaces are designed to understand and respond to user queries in a manner that simulates human conversation, leveraging advancements in language models to provide increasingly sophisticated and contextually relevant responses. The field encompasses various technologies for processing and evaluating textual and multi-modal inputs, ensuring that the interactions adhere to predefined standards of appropriateness and relevance.

### SUMMARY

Techniques are disclosed for semantic moderation of conversational agents.

In one embodiment, a system includes a memory having instructions, and a processor communicatively coupled to the memory and configured to execute the instructions. The instructions include scoring a received input string against a plurality of target classes to derive two or more scores, where each target class is associated with an independent score, and the scoring is performed without applying a softmax function to the independent scores; using the scores to generate a rule-based determination that indicates whether to pass or filter the input string; upon a determination to filter the input string, performing filtering processing on the input string; and otherwise, performing output processing on the input string.

In some embodiments, the input string is scored using a ZSC. In some embodiments, the ZSC can be configured in a multi-label mode. The multi-label mode can allow the input string to be classified into more than one target class contemporaneously. The ZSC can be a lightweight language model that operates without requiring a generalist LLM or access to external APIs. The ZSC can be based on a language model trained on tasks involving evaluation of similarity or entailment between strings. The rule-based determination can be generated using a decision tree. The rule-based determination to filter the input string can include applying a set of threshold scores for particular target classes that are deemed unacceptable. The system can be used to moderate content in an enterprise environment for interaction with internal policies and documentation. Scoring the input string can include using prompt engineering with various labels and example sentences to verify correct capture of aspects of the sentences that are useful for the content moderation. The instructions can further include extending moderation capabilities to multi-modal inputs that represent a combination of modalities, if a multi-modal ZSC exists for the combination of modalities. The filtering processing can include: blocking the input string from further processing; and performing one or more of the following: providing a predetermined response to a user; notifying a moderator or security team about the input string; or modifying the input string. A conversational agent that received the input string can be configured to perform the further processing. The output processing can include: allowing the input string to proceed for further processing; and performing one or more of the following: providing a predetermined response to a user; or modifying the input string. The input string can be received from a user or a conversational agent. The independent scores can range between 0 and 1.

Other example embodiments include, without limitation, apparatus, systems, methods, and computer program products comprising processor-readable storage media.

Other aspects will be apparent from the following detailed description and the amended claims.

### BRIEF DESCRIPTION OF THE DRAWINGS

The foregoing summary, as well as the following detailed description of exemplary embodiments, will be better understood when read in conjunction with the appended drawings. For purposes of illustrating the invention, the drawings illustrate embodiments that are presently preferred. It will be appreciated, however, that the invention is not limited to the precise arrangements and instrumentalities shown.

In the drawings:

FIG. 1 discloses aspects of an example moderation system, in accordance with illustrative embodiments.

FIG. 2 discloses a flowchart of an example method, in accordance with illustrative embodiments.

FIG. 3 discloses aspects of an example decision tree, in accordance with illustrative embodiments.

FIGS. 4A, 5A, and 6A disclose aspects of working examples, in accordance with illustrative embodiments.

FIGS. 4B, 5B, and 6B disclose aspects of example decision trees, in accordance with illustrative embodiments.

FIG. 7 discloses aspects of a computing entity configured and operable to perform any of the disclosed methods, processes, and operations, in accordance with illustrative embodiments.

### DETAILED DESCRIPTION

Example embodiments generally relate to artificial intelligence applied to content moderation. More specifically, at least some embodiments relate to systems, hardware, software, computer-readable media, and methods for artificial intelligence applied to content moderation for conversational agents, also known as chatbots.

Disclosed herein are techniques for content moderation. The present solution provides semantic moderation of conversational agents that is both lightweight and capable of operating on-premises. Example embodiments include an input interface, a classifier, a determination module, and an output interface. In one implementation, the classifier includes a Zero Shot Classifier (ZSC) and the determination module is rule-based and includes a Decision Tree (DT). The ZSC is configured to score input strings against multiple target classes without the need for a softmax function, allowing for multi-label classification where each class is associated with an independent score. The DT receives these scores and determines whether to pass or filter the input string, with the output interface executing the decision.

Technical advantages of the disclosed techniques include lightweight semantic moderation capability, which does not require the computational resources of a generalist LLM or external API access. The ZSC used in some embodiments is a smaller, more focused model that can run on standard customer-grade computers. In some embodiments the moderation solution's interpretability and transparency are enhanced by the use of a DT, which allows for clear mapping of decisions back to human-understandable labels and scores. Example embodiments also facilitate on-premises deployment, avoiding privacy and security concerns associated with external APIs.

Furthermore, the present system is designed to leverage a smaller dataset for supervised training of the DT, reducing costs and the exposure of human raters to offensive content. The ZSC can be trained on tasks involving the evaluation of similarity or entailment between strings, and the moderation system can be extended to multi-modal inputs if a corresponding multi-modal ZSC is available.

The disclosed techniques relate to the realm of content moderation, more specifically of conversational agents (sometimes referred to as chatbots).

The advent of stronger language models has led to higher adoption of AI (artificial intelligence) for creating interfaces between users and informative content such as documentation, presentations, search results, and videos, among others.

A few content retrieval developments have paved the way for users to more effectively key relevant data to answer their questions and queries. However, in most cases, simply retrieving the relevant information is not the desired end goal if the user would be forced to read the information with no other method of further interaction. In many cases, the solutions for these types of use cases involve combining the information retrieval tools with machine learning (ML) models, often large language models (LLMs) that act as a conversational agent and can respond to questions about the data.

In an enterprise environment, this combination can be highly valuable both for employees and customers, since a well-informed chatbot can make interacting with internal policies and documentation much easier.

One issue that arises in this scenario is the prevention of abuse and misuse, both in the case of the user attempting to use the chatbot for harmful purposes, as well as in the case where the chatbot might output offensive or harmful content prior to further processing.

In this sense, there is a need for solutions in the realm of automated moderation both to control what users may request of chatbots, and what chatbots may or may not reply to users.

Disclosed herein are example embodiments that utilize a small ZSC, potentially enhanced by a DT. The present solution acts as a transparent and interpretable moderator, capable of running locally without the need for external API or expensive development. The disclosed techniques offer superior protection than a simple conventional bad-word filter while being more feasible than conventional reinforcement learning with human feedback (RLHF) or generalist large language model (LLM) solutions.

It is noteworthy that a ZSC by itself may not be capable of moderating with the same level of performance as the disclosed techniques, which in one implementation combine the ZSC with a DT, as discussed in further detail herein.

For example, some ZSC labels might exhibit poor performance when used individually to classify a given dataset (e.g., “dangerous activity”), but when combined with other poor performance labels, actually result in unexpectedly strong performance due to the use of the trained decision tree. One intuition for this unexpected result seems to be that each individual ZSC label may act as a weak classifier, and the decision tree creates a stronger classifier by acting like an ensemble of those weaker classifiers.

Advantageously, the disclosed techniques provide a lightweight language model-based moderator that does not require a heavyweight generalist large language model and/or access to external APIs. The disclosed approach can be achieved leveraging models that easily run on customer grade computers, without requiring GPU (graphics processing unit) access. In some embodiments, the usage of ZSC models further allows for human language nuance leveraging that cannot be matched by simple conventional bad-word filters.

The use of a DT for making the final decision based upon the expert label scores allows for a level of transparency that cannot be matched by black box LLM moderator solutions. Every decision of the DT can be mapped back to the human language labels of the ZSC and analyzed according to the decision path of the DT. Advantageously, some embodiments use a ZSC combined with a DT to enable this purpose.

Unlike conventional solutions such as a moderator API offered by OpenAI, Inc., California, United States that requires external cloud or network connectivity, the present solution can be deployed on-premise, without requiring enterprises or customers to upload any of their data to external online APIs.

In some embodiments, the DT can be pretrained rather than hard-coded. In connection with such embodiments, the number of annotated samples can be smaller than what would be typically necessary for performing conventional RLHF on a generalist LLM. Advantageously, this results in both a reduction in costs compared to RLHF but also a reduction of the exposure of human raters to harmful and offensive content.

Specific embodiments will now be described in detail with reference to the accompanying figures. In the following detailed description of example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

### A. Context for an Example Embodiment

The following is a discussion of a context for example embodiments. This discussion is not intended to limit the scope of the invention, or the applicability of the embodiments, in any way.

Conventional attempts to solve the moderation issue have involved one or more of the approaches, discussed in further detail in the sections following:
Bad-word lists containing forbidden terms that are filtered either in pre- or post-processing of inputs/outputs
Reinforcement Learning with Human Feedback, which aims to steer a model, via gradient descent enforced policies, to follow human preference using large, annotated datasets
Using a Generalist Large Language Model itself as a moderator to filter out unacceptable questions or answers

Conventional bad-word lists are a quite simple and cheap solution but can be easily evaded in many cases, while conventional RLHF is costly, hard to execute, and involves exposing human raters to harmful content. Further, a conventional generalist LLM solution can only be significantly achieved by a few major enterprises with specific expertise and massive datasets. Also, a conventional generalist LLM is not a realistic solution for users that have privacy concerns and want to keep solutions on-premises, without uploading and potentially exposing their internal data to external application programming interfaces (APIs).

### A.1. Bad-Word Filters

Conventional bad-word filters exist online and could hypothetically be used in tandem with the present solution. However, such conventional filters have a shortcoming that the filters can typically be avoided in a few ways, and users can still elicit bad behaviors by a chatbot by using different combinations of words that are not in the bad-word filter but still achieve undesirable, offensive, or harmful results.

The same disadvantage holds true for applying a conventional bad-word filter to potentially harmful or offensive outputs that a chatbot may provide.

### A.2. RLHF

Conventional reinforcement learning with human feedback refers to a technique in which human feedback is used to steer a model (typically, a text-generation LLM) indirectly through a type of reinforcement learning referred to as proximal policy optimization (PPO).

For purposes of the present disclosure, in pertinent part conventional RLHF can be used to make models less prone to making offensive statements, among other undesirable behaviors. However, it is becoming increasingly appreciated that training models via conventional RLHF typically requires exposing human raters to harmful content, besides requiring large data collection efforts.

### A.3. Generalist LLMs as Moderators

The use of conventional generalist LLMs as moderating agents is also a venue being explored, for example by OpenAI. In a report describing the large multimodal model GPT-4 (a generative pre-trained transformer model), OpenAI mentions how GPT-4 itself can be used as a reward model in its own training. Accordingly, in a way GPT-4 is acting as a moderator of its own outputs.

This conventional approach has been done with extremely powerful and heavyweight LLMs that currently are only accessible via external APIs (application programming interfaces). This makes it impossible to use such models for private sensitive scenarios where on-premise models are desired.

### A.4. Zero Shot Classifiers

As used herein, a ZSC refers to any model configured to perform classification on previously unseen labels.

This is in contrast with conventional classifiers that are specifically trained to match inputs to a few fixed classes.

ZSC classifiers are seen in the context of language modelling and are readily available in many open-source implementations.

To turn a given language model into a zero-shot classifier, the model is typically trained on other language tasks that involve evaluating a similarity or entailment between two or more strings, and the output of this task can then be converted onto a classification prediction for arbitrary labels.

In one implementation, the open-source model bart-large-mnli provided by Meta Platforms, Inc., California, United States was trained on an entailment task and can be used as a ZSC. Generally, entailment models return as outputs whether a hypothesis entails, denies, or is neutral, towards a given premise. In the case of zero shot classification these three outputs are converted into a single score that relates to whether a given input (e.g., “apple”) belongs to a given label (e.g., “fruit”). This is akin to asking whether “the item is an apple” entails “item is a fruit.”

Language models that learn to capture nuances and semantics of a language can generally perform well in this type of task, while being available at a much smaller size than conventional full-fledged generalist LLMs that also need to learn many other tasks and behaviors (such as generating text, chatting, and the like).

### B. Overview of Aspects of an Example Embodiment

### B.1. Introduction

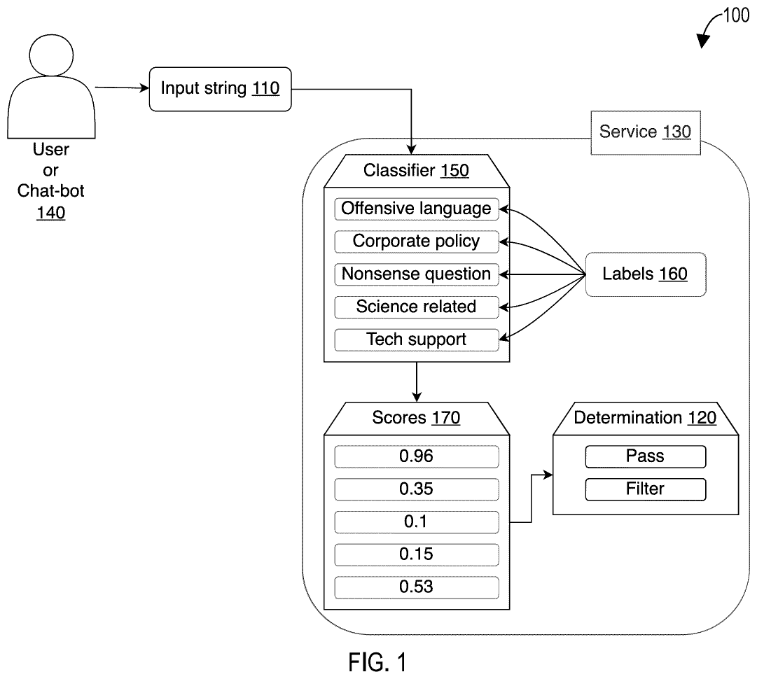

FIG. 1 shows aspects of an example moderation solution 100, in accordance with illustrative embodiments. In particular, FIG. 1 illustrates the moderation solution configured to process received input strings 110 and generate a determination 120.

In example embodiments, the service 130 implements the present moderation techniques. As used herein, the term “service” refers to an automated program that is tasked with performing different actions based on input. In some cases, the service can be a deterministic service that operates fully given a set of inputs and without a randomization factor. In other cases, the service can be or can include a ML or artificial intelligence engine. The ML engine enables the service to operate even when faced with a randomization factor.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (SVM), artificial intelligence device(s), or any other type of intelligent computing system. Any amount of training data may be used (and perhaps later refined) to train the machine learning algorithm to dynamically perform the disclosed operations. As discussed in further detail herein, example training data can include collected input text such as the input strings 110.

In some implementations, the service 130 is a cloud service operating in a cloud environment. In some implementations, the service is a local service operating on a local device, such as a server. In some implementations, the service is a hybrid service that includes a cloud component operating in the cloud and a local component operating on a local device. These two components can communicate with one another.

In one case, example steps involved in the present solution include the following:
1. Receiving an input string 110, for example either from a user or a conversational agent 140;
2. Using a classifier 150 to score the string against several target classes 160, for example a ZSC;
3. Making a determination 120, for deciding whether further action is necessary upon the input, for example a rule-based determination such as a DT, either manually written or trained automatically; and
4. Filtering or passing the message on.

Sometimes users 140 might query LLMs with messages 110 that include terms listed in bad-word collections, but without having malicious intent. For instance, a friendly user might input to the model strings like “How to protect against hacking” or “Signs that a colleague is being harassed,” which contain words listed as bad but that, in their respective sentences, should not be categorized as misusage. Therefore, simply checking if the strings contain these words is not enough to create a robust abuse moderator, indicating the need for a model able to evaluate their meaning contextualized in sentences.

FIG. 1 shows an example overview diagram for ease of discussing the present solution. Either a user or a chatbot 140 sends a message 110 to be evaluated by the service 130 before proceeding with further processing. One implementation of the automatic moderator includes a multi-label ZSC 150 with labels 160 previously defined by experts. The classifier 150 scores the inputs for each label. Since the classifier can do multi-label classification, each label receives an independent score 170, for example between 0 and 1. Scores of different labels are independent of each other, meaning that a given string might be classified as more than one label at a time.

In one implementation, the scores are then passed to a determination 120, such as a DT (which was either manually hard coded by experts or trained from collected samples), which makes the decision to pass or filter the message.

FIG. 1 shows messages 110 being sent by users/chatbots 140 as strings, which in example embodiments are passed onto a classifier 150 such as a multi-label ZSC that independently scores the input against a set of labels 160, for example chosen by subject matter experts. The scores 170 can have values between 0 and 1, and are independent from one another, meaning the input strings may correspond to more than a single class. The scores are passed on as input to a determination 120 such as a Decision Tree that makes the final call to pass or filter the message onward.

In some embodiments, the ‘filtering’ decision may have different meanings in different use cases, thereby involving different filtering processing corresponding to the different use cases. For example, the filtering processing may range from completely blocking the message 110 and providing a hard-coded answer, to notifying a human moderation or security team, to refining or reformulating the message (for example, in the case where it comes from a chatbot 140).

### C. Detailed Description of Aspects of an Example Embodiment

### C.1. Receiving Input String

Typically, interactions involving conversational agents are in the realm of text messages, although increasingly multi-modal AI models are becoming ubiquitous.

Although the techniques discussed herein focus on text strings as input messages for ease of illustration, the reasoning presented herein can be extended to other modalities of inputs without loss of generality. In some cases, if a multi-modal ZSC exists for the combination of the modalities of text and whichever other modality is being considered, then the disclosed techniques are configured to leverage such multi-modal ZSC, without departing from the scope of the example embodiments.

For example, in some embodiments if the present solution is expanded to process images as input, a multi-modal text-image ZSC can be used to classify images against a set of text labels. One such example classifier model includes a contrastive language-image pretraining model (CLIP), available from OpenAI, that is configured to predict a most relevant text snippet given an input image.

### C.2. Using a ZSC for Scoring the Input Against Labels

Example embodiments of a ZSC can score inputs in the following ways when there are multiple labels present: multi-class or multi-label.

With reference to FIG. 1, as used herein in AI/ML contexts, “multi-class” refers to classifications where there are multiple classes or labels 160 that an input 110 belongs to, but only a single answer is accepted. This means that even if 100 labels are available, only one will be considered the predicted answer. In some cases this single answer is achieved by applying a softmax function to the predictions, to generate a sum of probabilities that totals 100%. In such case, the probabilities of each label are not independent of each other, and it is not possible for the input to belong to more than one class at the same time.

In contrast, in a multi-label classification the input 110 can belong to more than one class. This is achieved by refraining from applying the softmax function to the predictions, which allows each label to have a corresponding, independent probability between 0 and 1. In example embodiments, the ZSC classifier is used in multi-label mode, without softmax applied to its output.

In example embodiments, a domain expert can assign the possible labels for the ZSC model in the following ways. The first approach, more qualitative, involves prompt engineering the ZSC model with various labels and example sentences to verify that the model is correctly capturing some aspect of the sentences that may be useful for the present moderation (e.g., whether the sentences are offensive, whether the sentences ask for security related topics, and the like).

An alternative approach, more quantitative in nature, leverages a dataset (for example, of a few hundred or thousand examples) to determine the performance of each label when the moderation system separates the dataset into pass/filter classes.

### C.3. Decision Tree

With continued reference to FIG. 1, in one implementation, the set of scores 170 generated by the ZSC 150 is then passed onto a DT 120.

As mentioned, in example embodiments this tree may be hard-coded and explicitly defined by experts. In alternate embodiments, the decision tree may be trained in case sample datasets are available.

With reference to FIG. 1, an example DT can include the following possible labels:
Offensive language, Corporate policy, Nonsense question, Science related, Tech support

In one implementation the classes ‘nonsense question’ and ‘offensive language’ may be deemed unacceptable, and the rest may be deemed acceptable. In this case, a score threshold can be defined, for example by experts, for the classes to be filtered (nonsense, offensive), and inputs 110 that score higher than the predetermined threshold are filtered.

As another example, consider the following set of labels for a company's internal system:
Compliance-related, Abuse, Ask for help, Corporate information

In example embodiments, the rule-based determination 120 includes, for example, via the DT, identifying that, if “compliance-related”, “abuse” and “ask for help” scores are simultaneously high, the string input 110 is classified as benign, while if only “compliance related” and “abuse” are high, this input is treated as malicious. Advantageously, the disclosed techniques allow for the example sentence “Signs that a colleague is being harassed” to pass through for processing by the model and would not be blocked.

In an alternate scenario, the DT may include a separate branch where inputs 110 detected to be ‘Tech support’ but also ‘offensive’ are especially filtered and result in a different answer being sent back (for instance, this may indicate an unsatisfied customer).

In some embodiments, upon accruing a dataset of acceptable/unacceptable inputs over time, a DT can be trained automatically that is configured to make its own decision path based on the scores for the expert labels.

### C.4. Filtering/Passing Message on

In example embodiments, the messages 110 that are passed or filtered receive further processing. For example, the messages may be further conditioned or reacted to differently based on findings of the determination 120. Building upon the previously discussed example, the present solution may output a different response for an unsatisfied customer that requested technical support but used offensive language, compared with an employee asking an unethical or nonsensical question that the chatbot 140 is unable to help with. In further embodiments, the present moderation solution may automate one or more policies to determine further processing for filtered messages.

### D. Example Methods

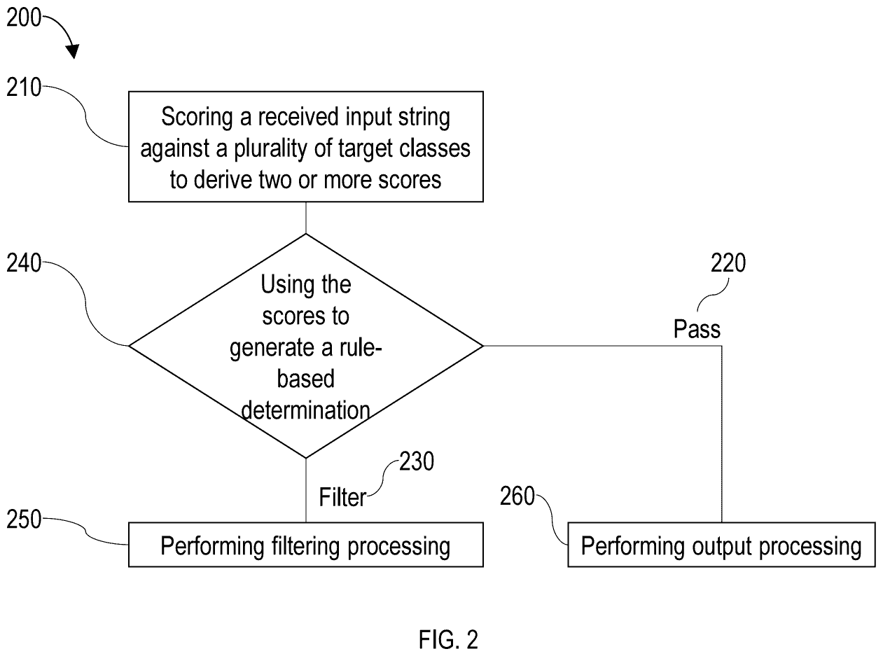

FIG. 2 shows a flowchart of an example method 200, in accordance with illustrative embodiments. In example embodiments, the method 200 allows for improved issue handling by identifying similar historical issues as references for a given issue.

In some embodiments, the method 200 can be performed by the moderation solution 100, such as using the service 130. In further embodiments, the present system is used to moderate content in an enterprise environment for interaction with internal policies and documentation.

In example embodiments, the method 200 includes scoring a received input string against a plurality of target classes to derive two or more scores (step 210). In some embodiments, the input string is received from a user or a conversational agent. In some embodiments, scoring the input string includes using prompt engineering with various labels and example sentences to verify correct capture of aspects of the sentences that are useful for the content moderation. In some embodiments, each target class is associated with an independent score. In some embodiments, the independent scores range between 0 and 1. In further embodiments, the scoring is performed without applying a softmax function to the independent scores. In some embodiments, the input string is scored using a ZSC. In further embodiments, the ZSC is configured in a multi-label mode. In still further embodiments, the multi-label mode allows the input string to be classified into more than one target class contemporaneously. In some cases, the ZSC is a lightweight language model that operates without requiring a generalist large language model or access to external APIs. In some embodiments, the ZSC is based on a language model trained on tasks involving evaluation of similarity or entailment between strings.

In example embodiments, the method 200 includes using the scores to generate a rule-based determination that indicates whether to pass 220 or filter 230 the input string (step 240). In some embodiments, the rule-based determination is generated using a DT. In some embodiments, the rule-based determination to filter the input string includes applying a set of threshold scores for particular target classes that are deemed unacceptable.

In example embodiments, the method 200 includes, upon a determination to filter 230 the input string, performing filtering processing on the input string (step 250). In some embodiments, the filtering processing includes blocking the input string from further processing; and performing one or more of the following: providing a predetermined response to a user; notifying a moderator or security team about the input string; or modifying the input string. In some embodiments, a conversational agent that received the input string is configured to perform the further processing.

In example embodiments, the method 200 includes, otherwise, performing output processing on the input string (step 260). In some embodiments, the output processing includes: allowing the input string to proceed for further processing; and performing one or more of the following: providing a predetermined response to a user; or modifying the input string.

In some embodiments, the method 200 includes extending moderation capabilities to multi-modal inputs if a multi-modal ZSC exists for the combination of modalities.

While the various steps in the example method 200 have been presented and described sequentially, one of ordinary skill in the art, having the benefit of this disclosure, will appreciate that some or all of the steps may be executed in different orders, that some or all of the steps may be combined or omitted, and/or that some or all of the steps may be executed in parallel.

It is noted with respect to the example method 200 that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

### D.1. Working Examples

The method 200 is discussed in further detail herein in connection with multiple working examples, to assist with illustrating example embodiments and not by way of limitation.

### D.1.1. Example Decision Tree

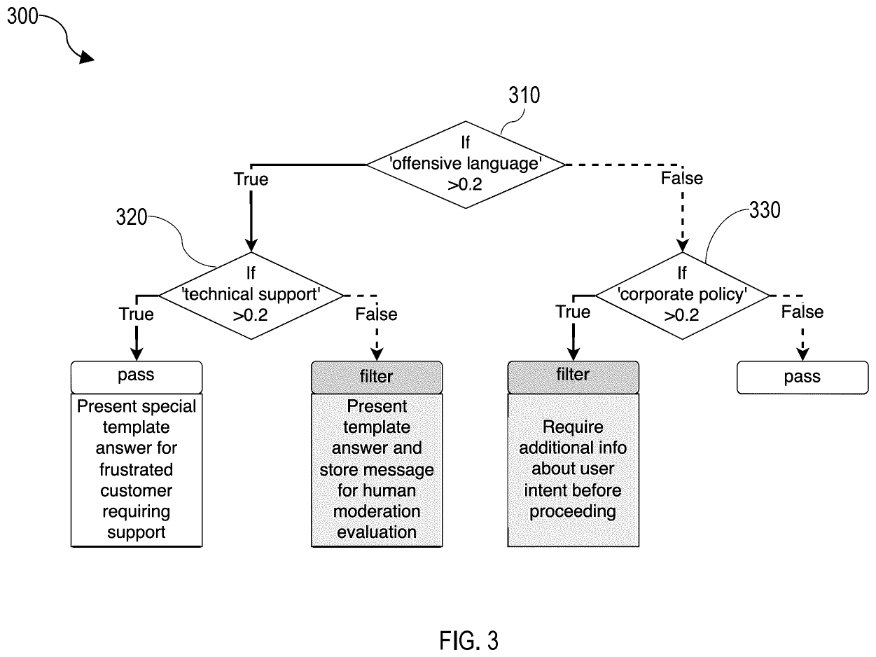

FIG. 3 shows aspects of an example decision tree 300, in accordance with illustrative embodiments.

In one implementation, the bart-large-mnli model from Meta Platforms, Inc., California, United States, was used as a ZSC alongside a predefined DT for the labels discussed in FIG. 1. Particularly, for the working examples discussed herein, the expert-defined labels included the following:
Offensive language, Corporate Policy, Nonsense question, Science related, Tech support

FIG. 3 shows the associated DT 300. Relevant labels for the working examples discussed herein included the “offensive language,” “technical support,” and “corporate policy” labels. These labels corresponded to the decision tree nodes 310, 320, 330, respectively, of the DT, as discussed in further detail herein.

### D.1.2. Working Example 1: Company Policies

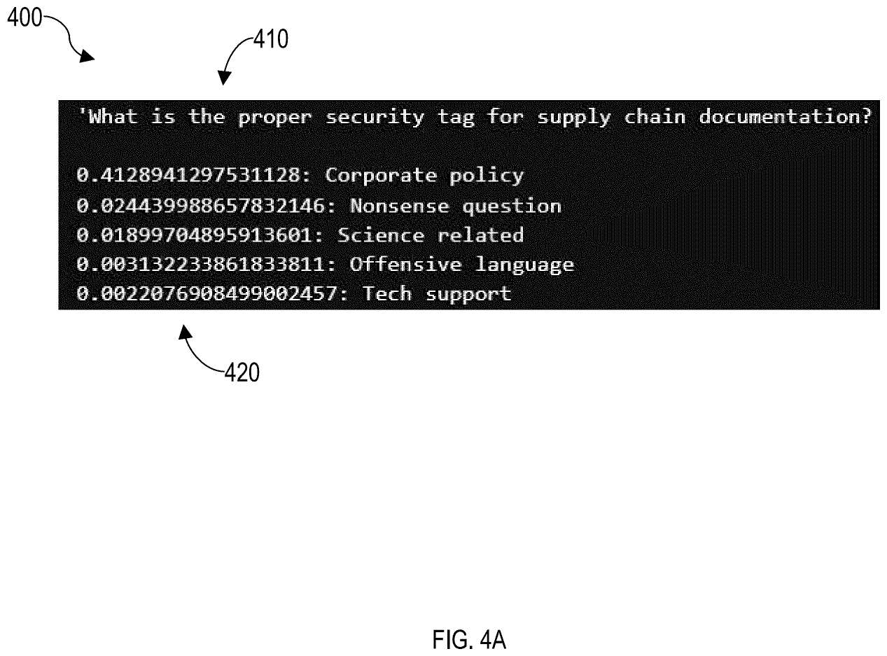

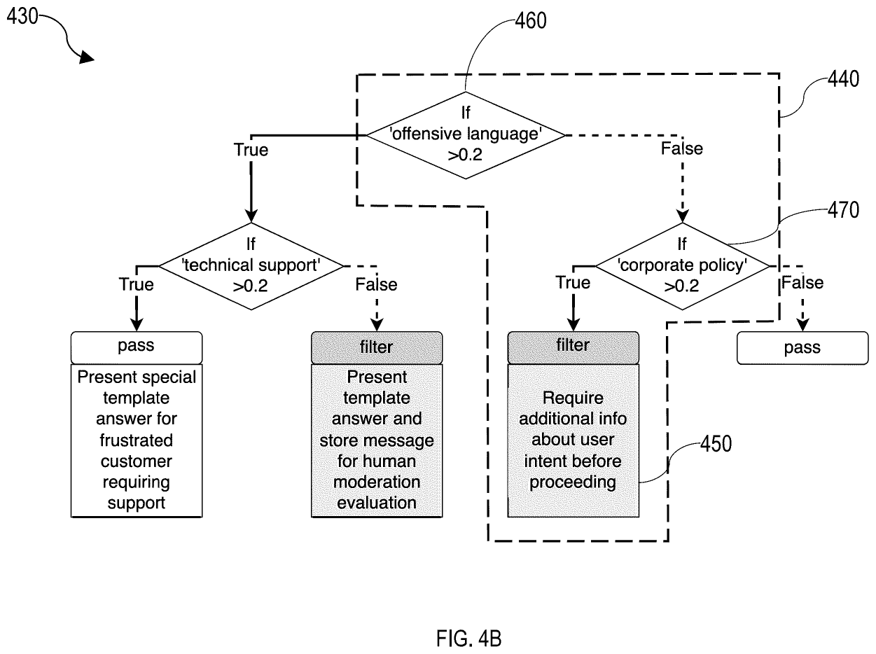

FIG. 4A shows aspects of a working example 400, in accordance with illustrative embodiments.

With reference to FIGS. 4A and 4B, the working example 400 illustrates the disclosed techniques processing an input message 410 “What is the proper security tag for supply chain documentation?” FIG. 4A shows the resulting scores 420 from the ZSC.

FIG. 4B shows aspects of an example decision tree 430, in accordance with illustrative embodiments.

With reference to FIGS. 4A and 4B, the working example 400 followed the decision tree path 440 and resulted in the response 450. More particularly, the present moderation used the scores 420 to determine that the question 410 related to the “corporate policy” label. The disclosed techniques followed the decision tree path based on the scores for “offensive language” and “corporate policy” according to the decision tree nodes 460, 470. Accordingly, consistent with the decision tree node 450 the disclosed techniques performed filtering processing, including blocking the input message from further processing, and requiring additional information to determine a user intent prior to the further processing.

### D.1.3. Working Example 2: Frustrated Customer

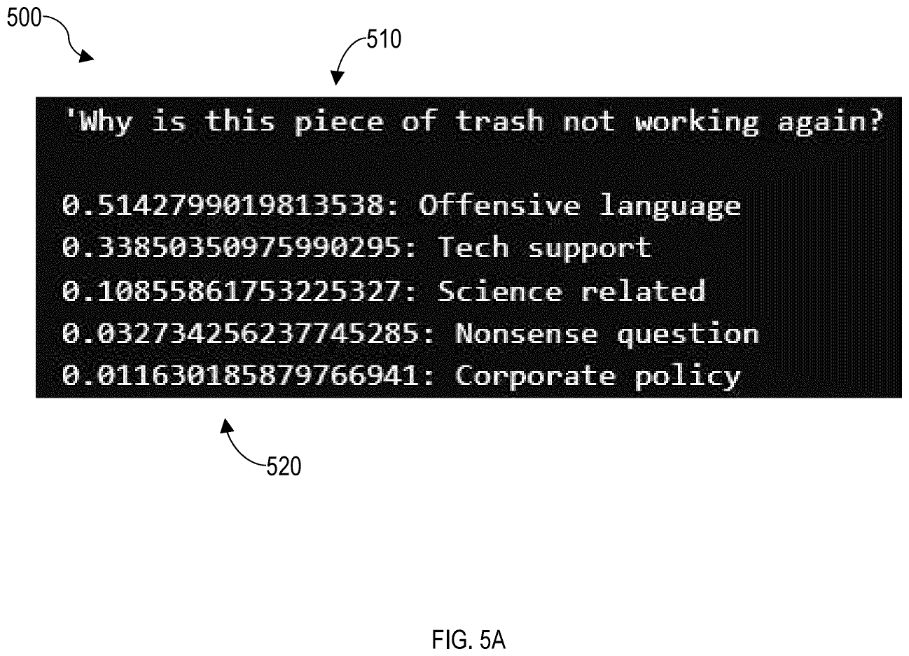

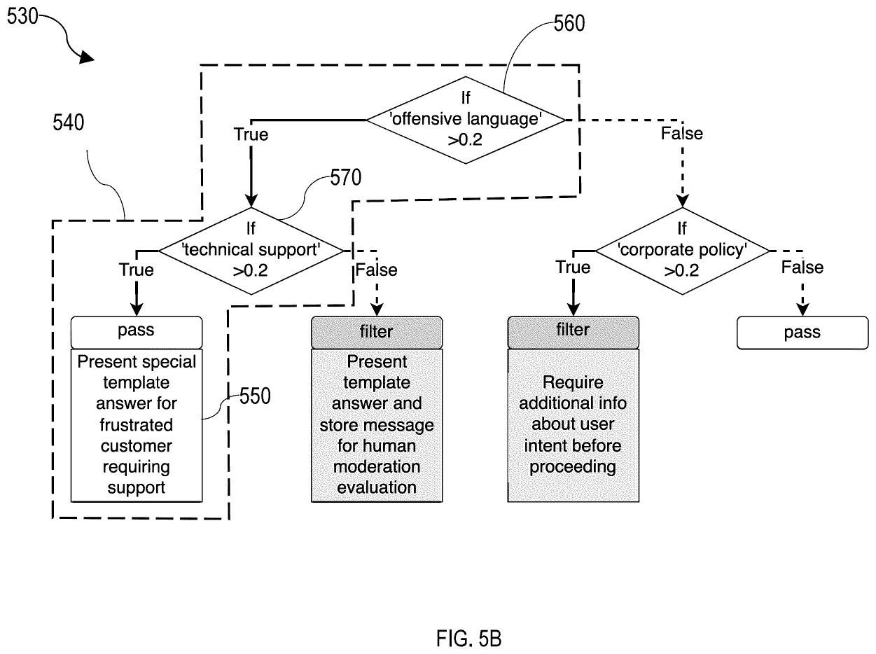

FIG. 5A shows aspects of a working example 500, in accordance with illustrative embodiments.

With reference to FIGS. 5A and 5B, the working example 500 illustrates the disclosed techniques processing an input message 510 “Why is this piece of trash not working again?” FIG. 5A shows the resulting scores 520 from the ZSC.

FIG. 5B shows aspects of an example decision tree 530, in accordance with illustrative embodiments.

With reference to FIGS. 5A and 5B, the working example 500 followed the decision tree path 540 and resulted in the response 550. More particularly, the present moderation used the scores 520 to determine that the question 510 related to the “technical support” label. The disclosed techniques followed the decision tree path based on the scores for “offensive language” and “technical support” according to the decision tree nodes 560, 570. Accordingly, consistent with the decision tree node 550 the disclosed techniques performed output processing, including allowing the user message 510 to proceed to the conversational agent though including an instruction requiring further processing to retrieve a special template answer for dealing with customer support.

### D.1.4. Working Example 3: Regular Message

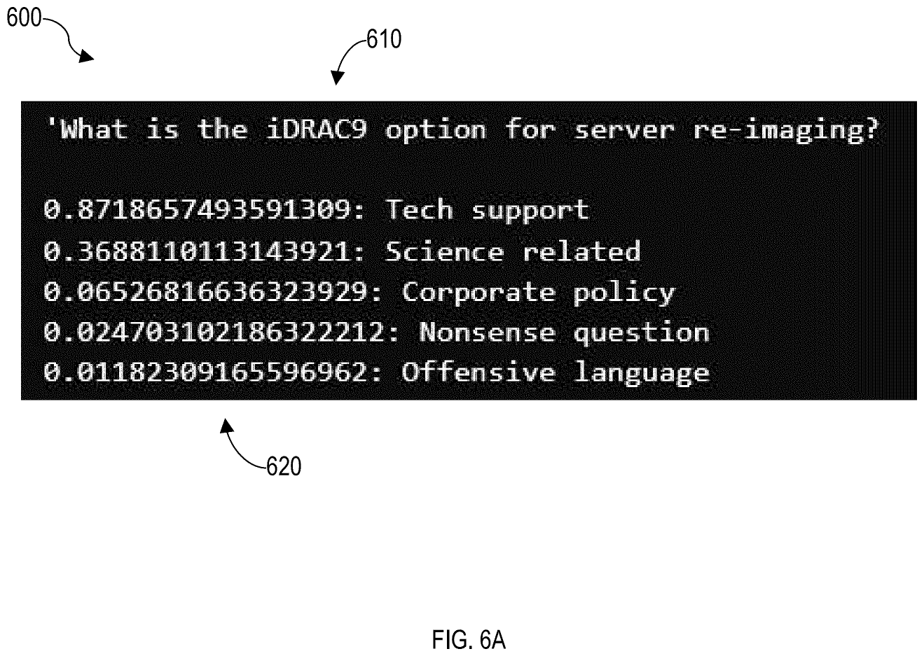

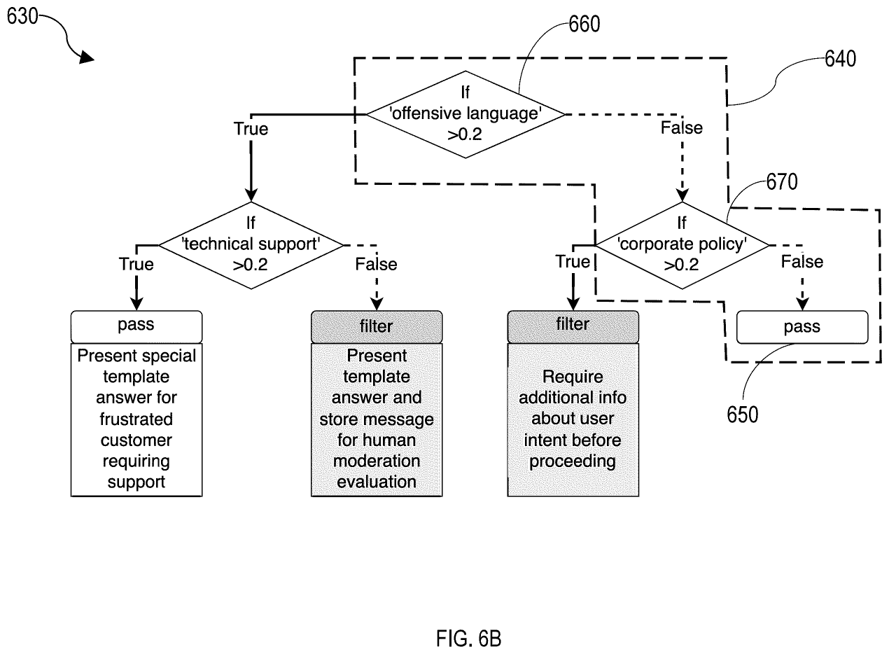

FIG. 6A shows aspects of a working example 600, in accordance with illustrative embodiments.

With reference to FIGS. 6A and 6B, the working example 600 illustrates the disclosed techniques processing an input message 610 “What is the iDRAC9 option for server re-imaging?” FIG. 6A shows the resulting scores 620 from the ZSC.

FIG. 6B shows aspects of an example decision tree 630, in accordance with illustrative embodiments.

With reference to FIGS. 6A and 6B, the working example 600 followed the decision tree path 640 and resulted in the response 650. More particularly, the present moderation used the scores 620 to determine that the question 610 related to the “technical support” label. The disclosed techniques followed the decision tree path 640 based on the scores for “offensive language” and “corporate policy” according to the decision tree nodes 660, 670. Accordingly, consistent with the decision tree node 650 the disclosed techniques performed output processing, including allowing the user message 610 to proceed unmodified, directly to the conversational agent, with no further processing needed.

### E. Processing Platform

At least portions of the present moderation system can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the present moderation system. For example, containers can be used to implement respective processing devices providing compute and/or storage services of a cloud-based system. Again, containers may be used in combination with other virtualization infrastructure such as virtual machines implemented using a hypervisor.

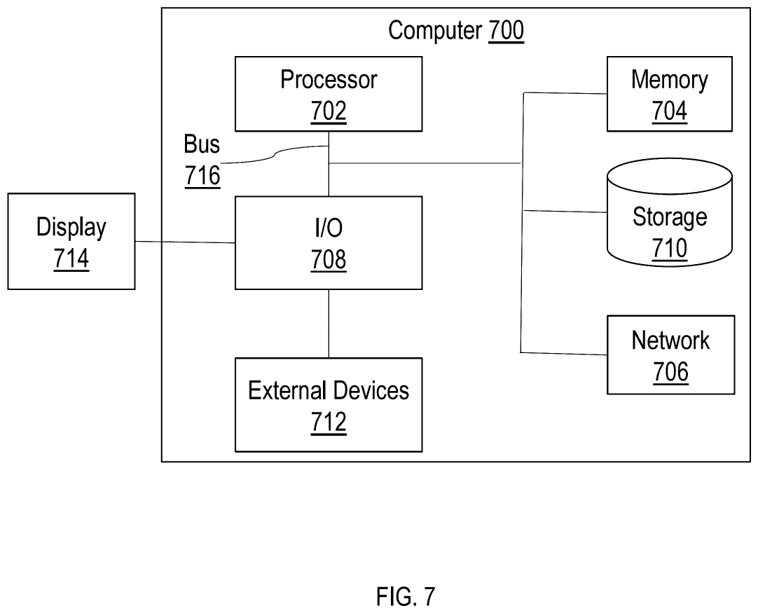

Illustrative embodiments of processing platforms will now be described in greater detail with reference to FIG. 7. Although described in the context of the present moderation system, these platforms may also be used to implement at least portions of other information processing systems in other embodiments.

FIG. 7 illustrates aspects of a computing device or a computing system in accordance with example embodiments. The computer 700 is shown in the form of a general-purpose computing device. Components of the computer may include, but are not limited to, one or more processors or processing units 702, a memory 704, a network interface 706, and a bus 716 that communicatively couples various system components including the system memory and the network interface to the processor.

The bus 716 represents one or more of any of several types of bus structures, including a memory bus or memory controller, a peripheral bus, an accelerated graphics port, and a processor or local bus using any of a variety of bus architectures. By way of non-limiting example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 700 typically includes a variety of computer-readable media. Such media may be any available media that is accessible by the computer system, and such media includes both volatile and non-volatile media, removable and non-removable media.

The memory 704 may include computer system readable media in the form of volatile memory, such as random-access memory (RAM) and/or cache memory. The computer system may further include other removable/non-removable, volatile/non-volatile computer system storage media. By way of example only, the storage system 710 may be provided for reading from and writing to a non-removable, non-volatile magnetic media (not shown and typically called a “hard drive”) in accordance with the present moderation techniques. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media may be provided. In such instances, each may be connected to the bus 716 by one or more data media interfaces. As has been depicted and described above in connection with FIGS. 1-6B, the memory may include at least one computer program product having a set (e.g., at least one) of program modules that are configured to carry out the functions of the embodiments as described herein.

The computer 700 may also include a program/utility, having a set (at least one) of program modules, which may be stored in the memory 704 by way of non-limiting example, as well as an operating system, one or more application programs, other program modules, and program data. Each of the operating system, one or more application programs, other program modules, and program data or some combination thereof, may include an implementation of a networking environment. The program modules generally carry out the functions and/or methodologies of the embodiments as described herein.

The computer 700 may also communicate with one or more external devices 712 such as a keyboard, a pointing device, a display 714, etc.; one or more devices that enable a user to interact with the computer system; and/or any devices (e.g., network card, modem, etc.) that enable the computer system to communicate with one or more other computing devices. Such communication may occur via the Input/Output (I/O) interfaces 708. Still yet, the computer system may communicate with one or more networks such as a local area network (LAN), a general wide area network (WAN), and/or a public network (e.g., the Internet) via the network adapter 706. As depicted, the network adapter communicates with the other components of the computer system via the bus 716. It should be understood that although not shown, other hardware and/or software components could be used in conjunction with the computer system. Non-limiting examples include microcode, device drivers, redundant processing units, external disk drive arrays, RAID systems, tape drives, data archival storage systems, and the like.

It is noted that embodiments of the invention, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

In the foregoing description of FIGS. 1-7, any component described with regard to a figure, in various embodiments of the invention, may be equivalent to one or more like-named components described with regard to any other figure. For brevity, descriptions of these components has not been repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

Throughout the disclosure, ordinal numbers (e.g., first, second, third, etc.) may have been used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

Throughout this disclosure, elements of figures may be labeled as “a” to “n”. As used herein, the aforementioned labeling means that the element may include any number of items and does not require that the element include the same number of elements as any other item labeled as “a” to “n.” For example, a data structure may include a first element labeled as “a” and a second element labeled as “n.” This labeling convention means that the data structure may include any number of the elements. A second data structure, also labeled as “a” to “n,” may also include any number of elements. The number of elements of the first data structure and the number of elements of the second data structure may be the same or different.

While the invention has been described with respect to a limited number of embodiments, those of ordinary skill in the art, having the benefit of this disclosure, will appreciate that other embodiments can be devised that do not depart from the scope of the invention as disclosed herein. Accordingly, the scope of the embodiments described herein should be limited only by the appended claims.

What is claimed is:

1. A system comprising:
a memory comprising instructions; and
a processor communicatively coupled to the memory and configured to execute the instructions, the instructions comprising:
scoring a received input string against a plurality of target classes to derive two or more scores, wherein each target class is associated with an independent score, and the scoring is performed without applying a softmax function to the independent scores;
using the scores to generate a rule-based determination that indicates whether to pass or filter the input string;
upon a determination to filter the input string, performing filtering processing on the input string; and
otherwise, performing output processing on the input string.

2. The system of claim 1, wherein the input string is scored using a zero-shot classifier (ZSC).

3. The system of claim 2, wherein the ZSC is configured in a multi-label mode, the multi-label mode allowing the input string to be classified into more than one target class contemporaneously.

4. The system of claim 2, wherein the ZSC is a lightweight language model that operates without requiring a generalist large language model or access to external application programming interfaces.

5. The system of claim 2, wherein the ZSC is based on a language model trained on tasks involving evaluation of similarity or entailment between strings.

6. The system of claim 1, wherein the rule-based determination is generated using a decision tree.

7. The system of claim 1, wherein the rule-based determination to filter the input string includes applying a set of threshold scores for particular target classes that are deemed unacceptable.

8. The system of claim 1, wherein the system is used to moderate content in an enterprise environment for interaction with internal policies and documentation.

9. The system of claim 8, wherein scoring the input string includes using prompt engineering with various labels and example sentences to verify correct capture of aspects of the sentences that are useful for the content moderation.

10. The system of claim 9, wherein the instructions further comprise extending moderation capabilities to multi-modal inputs that represent a combination of modalities, if a multi-modal ZSC exists for the combination of modalities.

11. The system of claim 1, wherein the filtering processing includes:
blocking the input string from further processing; and
performing one or more of the following:
providing a predetermined response to a user;
notifying a moderator or security team about the input string; or
modifying the input string.

12. The system of claim 11, wherein a conversational agent that received the input string is configured to perform the further processing.

13. The system of claim 1, wherein the output processing includes:
allowing the input string to proceed for further processing; and
performing one or more of the following:
providing a predetermined response to a user; or
modifying the input string.

14. The system of claim 1, wherein the input string is received from a user or a conversational agent.

15. The system of claim 1, wherein the independent scores range between 0 and 1.

16. A method comprising:
scoring a received input string against a plurality of target classes to derive two or more scores, wherein each target class is associated with an independent score, and the scoring is performed without applying a softmax function to the independent scores;
using the scores to generate a rule-based determination that indicates whether to pass or filter the input string;
upon a determination to filter the input string, performing filtering processing on the input string; and
otherwise, performing output processing on the input string.

17. The method of claim 16, wherein the input string is scored using a zero-shot classifier (ZSC).

18. The method of claim 16, wherein the rule-based determination is generated using a decision tree.

19. The method of claim 16, wherein the filtering processing includes:
blocking the input string from further processing; and
performing one or more of the following:
providing a predetermined response to a user;
notifying a moderator or security team about the input string; or
modifying the input string.

20. A non-transitory processor-readable storage medium having stored thereon program code of one or more software programs, wherein the program code when executed by at least one processing device causes the at least one processing device to perform the following steps:
scoring a received input string against a plurality of target classes to derive two or more scores, wherein each target class is associated with an independent score, and the scoring is performed without applying a softmax function to the independent scores;
using the scores to generate a rule-based determination that indicates whether to pass or filter the input string;
upon a determination to filter the input string, performing filtering processing on the input string; and
otherwise, performing output processing on the input string.
